(19) United States
(12) Patent Application Publication
(10) Pub. No.: US 2013/0312903 A1
(43) Pub. Date: Nov. 28, 2013

(54) Curing Device for Sealant of LCD Panel and Method for Curing the Sealant

(71) Applicants: Shaoxin Yu, Shenzhen (CN); Song Xiao, Shenzhen (CN); Yun Wang, Shenzhen (CN)

(72) Inventors: Shaoxin Yu, Shenzhen (CN); Song Xiao, Shenzhen (CN); Yun Wang, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/574,604

(22) PCT Filed: May 31, 2012
(86) PCT No.: PCT/CN2012/076327

§ 371 Date: Jul. 21, 2012

(30) Foreign Application Priority Data
May 22, 2012 (CN) 201210160612.8

(51) Int. Cl. B32B 37/06

(52) U.S. Cl. 156/275.5; 156/379.6

(57) ABSTRACT

The present invention provides a curing device for sealant, and which includes an ultraviolet light source, and a waveguide. A light beam projected from the ultraviolet light source enters the waveguide. The waveguide includes multiple light emitting ports, and the light beam emits from the multiple light emitting ports after one or several total internal reflection. The multiple light emitting ports are arranged and distributed according to the positions of the sealant to be cured. The present invention further provides a method for curing the sealant. The curing device and the method for curing the sealant can readily increase the efficiency of utilization of the ultraviolet light source, while it can readily reduce the cost associated thereof. In addition, since the ultraviolet light beam is precisely directed to the area in which the sealant locates, the liquid crystal can be properly protected from pre-matured random alignment of the molecular of the liquid crystal resulted from exposure of the ultraviolet.

### FIELD OF THE INVENTION

The present invention relates to a technology of manufacturing of liquid crystal display module, and more particularly, to a curing device for curing and hardening a sealant used in the LCD panel, and a method for curing the sealant.

### Field of the Invention

The liquid crystal display device is featured with low radiation, compact, slim and low energy exhaustion, it has been widely used in mobile phone, personal digital assistant, notebook computer, personal computer and television.

During the manufacturing of the LCD, a sealant used to combine the TFT substrate and CF substrate has to be cured and hardened after the sealant is applied therebetween. In general, an ultraviolet light is used to cure and harden the sealant. After the sealant is firstly cured by the ultraviolet, then the sealant is further undergoing a heat curing.

When the LCD panel is undergoing the process of curing, normally, the ultraviolet light is installed above the LCD panel, and then the ultraviolet light will project its beam toward the LCD panel and the sealant. However, certain type of liquid crystal is very sensitive to the ultraviolet. As a result, the LCD panel has to be masked so as to prevent the liquid crystal from the pre-matured random alignment of the molecular of the liquid crystal as it is exposed under the ultraviolet. In real practice, the entire LCD panel has to be masked except the area in which the sealant exists. Nevertheless, not all the LCD panel area needs to be exposed under ultraviolet, only the area in which the sealant exists is required to be exposed with the ultraviolet. Accordingly, in view of the efficiency, the energy from the ultraviolet is mostly wasted as it is projected to the masked area of the LCD panel.

On the other hand, the cost of installation of the ultraviolet is comparatively expensive. For example, in the 8.5 generation of the LCD production line, each installation of the ultraviolet light is about RMB20.000, and totally eight (8) ultraviolet lights are required. Accordingly, the ultraviolet light tube becomes the biggest expendable material in the curing device.

Accordingly, the current curing device for the sealant of the LCD panel is comparatively poor, and inevitably increases the manufacturing cost.

### SUMMARY OF THE INVENTION

It is the purpose of the present invention to provide a solution to the low and poor efficiency of the existing curing device for curing a sealant deployed on LCD panel with ultraviolet as well as the cost associated thereof.

In order to resolve the technical issue encountered by the prior art, the present invention introduce a curing device for sealant of LCD panel comprising an ultraviolet light source and a waveguide. Wherein a light beam from the ultraviolet light source is directed into the waveguide which includes multiple light emitting ports. Wherein the ultraviolet light beam from the light source emits from the multiple ports after refractions within the waveguide, wherein the multiple ports are arranged in alignment to the sealant. Wherein the waveguide includes multiple light incident ports, wherein the curing device further includes filter units arranged between the multiple light incident ports and the ultraviolet light source. Wherein the light beam from the ultraviolet light source is directed into the waveguide from the multiple light incident ports after passing through the filter unit, the waveguide including multiple L-shaped waveguide tubes, and each of the L-shaped waveguide tube includes first and second ports on both ends, wherein first port receives the light beam from the ultraviolet light source, the second port is directed and aligned toward the sealant, wherein the L-shaped waveguide tube has a telescopic configuration.

Wherein the filter absorbs the wavelength which is longer and shorter than the wavelength of the ultraviolet light.

Wherein each of the waveguides includes an internal refractive surface which directs the light beam from the first port to the second port, and finally to the correction in which the sealant locates.

In order to resolve the prior art issue, the present invention introduces a curing device for sealant which comprises an ultraviolet light source and a waveguide. Wherein light beam emitted from the ultraviolet source is directed into the waveguide, and wherein the waveguide includes multiple light emitting ports. Wherein the light beam is emitted from the light emitting ports after reflected within the waveguide, wherein the light emitting ports are arranged with respect to an area in which the sealant is located.

Wherein the waveguide includes multiple light incident ports, and further includes a filter arranged between the ultraviolet light source and the multiple light incident ports, wherein the light beam emitted from the ultraviolet light source enters into the waveguide after the light beam passes through the filter and entering through the light incident ports.

Wherein the filter absorbs the wavelength which is longer and shorter than the wavelength of the ultraviolet light.

Wherein the waveguide includes a plurality of fiber optic bundled together, a first end of the fiber optic is directed toward the ultraviolet light source, and the second end is directed to the sealant to be cured.

Wherein the waveguide includes multiple L-shaped waveguide tubes, and each of the L-shaped waveguide tube includes first and second ports on both ends, wherein first port receives the light beam from the ultraviolet light source, the second port is directed and aligned toward the sealant, wherein the L-shaped waveguide tube has a telescopic configuration.

Wherein each of the waveguides includes an internal refractive surface which directs the light beam from the first port to the second port, and finally to the correction in which the sealant locates.

Wherein the waveguide has a telescopic configuration.

In order to resolve technical issue encountered by the prior art, the present invention further provides a method for curing sealant, comprises the steps of a) providing an ultraviolet light source emitting ultraviolet light beam; b) providing a waveguide having multiple light emitting ports directing the ultraviolet light beam toward an area in which the sealant locates after the light beam is reflected within the waveguide; and c) projecting the light beam through the multiple light emitting ports toward the sealant to be exposed.

Wherein the light beam is reflected once or more than once within the waveguide before it is emitted from the multiple emitting ports

Wherein after the position of the sealant to be cured is changed, the multiple light emitting ports are adjusted accordingly such that the multiple light emitting ports are aligned with the sealant to be cured.

In order to resolve the technical issue encountered by the prior art, the present invention introduce a curing device for sealant of LCD panel comprising an ultraviolet light source and a waveguide. Wherein a light beam from the ultraviolet light source is directed into the waveguide which includes multiple light emitting ports. Wherein the ultraviolet light beam from the light source emits from the multiple ports after refractions within the waveguide, wherein the multiple ports are arranged in alignment to the sealant. Wherein the waveguide includes multiple light incident ports, wherein the curing device further includes filter units arranged between the multiple light incident ports and the ultraviolet light source. Wherein the light beam from the ultraviolet light source is directed into the waveguide from the multiple light incident ports after passing through the filter unit, the waveguide including multiple L-shaped waveguide tubes, and each of the L-shaped waveguide tube includes first and second ports on both ends, wherein first port receives the light beam from the ultraviolet light source, the second port is directed and aligned toward the sealant, wherein the L-shaped waveguide tube has a telescopic configuration.

According to a preferred embodiment of the present invention, wherein the filter absorbs the wavelength which is longer and shorter than the wavelength of the ultraviolet light.

According to one preferred embodiment of the present invention, wherein each of the waveguides includes an internal refractive surface which directs the light beam from the first port to the second port, and finally to the correction in which the sealant locates.

The curing device and the method for curing the sealant for LCD panel made in accordance with the present invention can readily increase the efficiency of utilization of the ultraviolet light source, while it can readily reduce the cost associated thereof. In addition, since the ultraviolet light beam is precisely directed to the area in which the sealant locates, the liquid crystal can be properly protected from the pre-matured random alignment of the molecular of the liquid crystal resulted from exposure of the ultraviolet.

### BRIEF DESCRIPTION OF DRAWINGS

In order clearly explain the technology of the embodiment illustrated in the present invention, a brief and concise description will be given along with the accompanied drawings. Apparently, the embodiments illustrated in the drawings are merely some typical embodiments and which can be readily modified by the skilled in the art without any additional laborious efforts so as to transform them into other drawings.

FIG. 1 is an illustrational and structural view of a curing device made in accordance with the first embodiment of the present invention; and

FIG. 2 is an illustrational and structural view of a curing device made in accordance with the second embodiment of the present invention.

### DETAILED DESCRIPTION OF PREFERRED EMBODIMENT

In order to give a better and thorough understanding to the whole and other intended purposes, features and advantages of the technical solution of the present invention, detailed description will be given with respect to preferred embodiments provided and illustrated herebelow in accompanied drawings. Apparently, with the spirit of the embodiments disclosed, person in the skilled in the art can readily come out with other modifications as well as improvements without undue experiment. In addition, other drawings can be readily achieved based on the disclosed drawings.

### First Embodiment

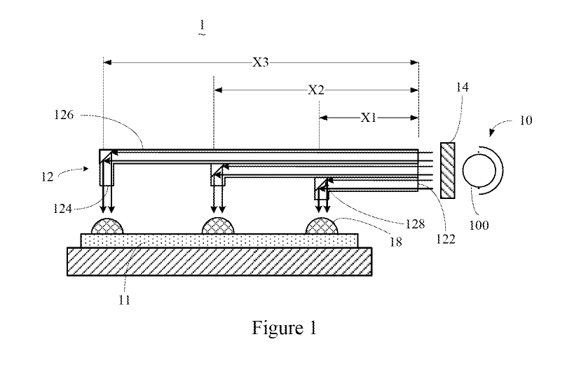

Referring to FIG. 1, the present invention discloses a curing device 1 for sealant, and which includes a ultraviolet light source 10, a waveguide 12 and a filter 14.

The ultraviolet light source 10 includes one or more than one ultraviolet light tube 100 with a wavelength between 4 to 380 nm so as to cure the sealant 16.

The filter 14 is arranged on the traveling path of the ultraviolet light, and the filter 14 can absorb any wavelength which is beyond the 4-380 nm ranges, i.e. any wavelength below and beyond will be absorbed by the filter 14. Accordingly, only the light beam having the wavelength 4˜380 nm can pass the filter 14, and any wavelength other than that range will be filtered.

The waveguide 12 includes multiple light incident ports 122 and multiple light emitting ports 124. The filter 14 is arranged between the ultraviolet light source 10 and the multiple light incident ports 122. The light beam projected from the ultraviolet light source 10 will enter the multiple incident ports 122 and further into the waveguide 12 after it passes through the filter 14. The light beam will come out from the multiple emitting ports 124 after one or more than once refraction within the waveguide 12, and then projects to the sealant 18 to be cured.

As shown in FIG. 1, in this embodiment, the waveguide 12 includes a plurality of L-shaped waveguide tube 126 having first and second ends. The first end 122 of the waveguide tube 126 serves as multiple light incident ports for receiving the light beam from the ultraviolet light source 10. The second end 124 of the waveguide tube 122 serves as multiple light emitting ports directing the light beam toward the sealant. The multiple light emitting ports 124 are scattered around with respect to the positions of the sealant 18 to be cured. The waveguide 126 can be integrally formed into the L-shaped configuration, or alternatively, it can be configured with two different waveguide tube jointed together.

The waveguide tube 126 may have different length, for example, the waveguide 126 can be cut into X1, X2, and X3 according to different field requirements. Alternatively, the waveguide 126 can be designed to have a telescopic configuration which can be readily adjusted by a motor so as to adjust its length according to the field requirements, i.e. the location of the sealant. As a result, LCD panel with different dimension can be readily used on this curing device. The cost is certainly reduced.

The waveguide tube 126 includes a refractive surface 128 refracting the light beam projected from the first end to the second end, and eventually projected onto the sealant 18. The refractive surface 128 can be formed by attaching a layer of metallic refractive foil or coating a layer of refractive material within the internal surface of the waveguide tube 126. It can be also formed by providing a mirror therein. For example, a refractive mirror can be disposed on the corner with 45 degrees with respect to the ultraviolet light beam. Accordingly, a horizontally incident ultraviolet light beam can be reflected 90 degrees to project onto the sealant 18 located below.

Each of the multiple light emitting ports 124 are arranged and distributed according to the positions of the sealant 18 to be cured. Accordingly, since the ultraviolet light beam is accurately directed to only the sealant 18, while the liquid crystal display will not be exposed under the ultraviolet light beam, not only will the efficiency of the utilization of the ultraviolet light increase, but also effectively prevent the pre-matured random alignment of the molecular of the liquid crystal because of the exposure of the ultraviolet light.

For the same substrate 11, if the area of the sealant 18 is “a”, and those non-sealant area is “b”, with the same amount needed to cure the sealant, the actual amount of the energy from the ultraviolet light source is “a/(a+b), it is merely a fraction of what prior art needed. Accordingly, the energy needed from the ultraviolet light source 10 can be reduce to “a/(a+b)”, i.e. either the quantity of the ultraviolet light tube 100 can be reduced, or the energy generated from the ultraviolet light tube can be reduced to only “a/(a+b)” as compared to originally. The manufacturing cost is effectively reduced. On the other hand, the ultraviolet light tubes 100 of the ultraviolet light source 10 can be centralized because of the application of the waveguide. As a result, in case of any replacement of the ultraviolet light tube 100, the maintenance can be readily done. On the other hand, since the length of the waveguide 126 can be readily adjusted according to the field requirements, different LCD panels with different dimensions can be readily cured with these curing device 1 made in accordance the present invention. The utilization of the curing device 1 according to the present invention is readily upgraded.

### The Second Embodiment

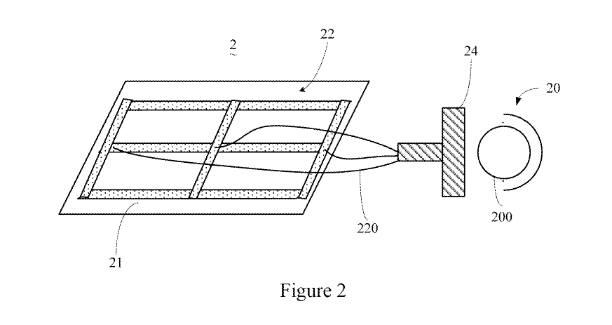

Referring to FIG. 2, the present invention introduces a curing device 2 which includes an ultraviolet light source 20, a waveguide 22, and a filter 24.

The ultraviolet light source 20 includes one or more than one ultraviolet light tube 200 with a wavelength between 4 to 380 nm so as to cure the sealant.

The filter 24 is arranged on the traveling path of the ultraviolet light, and the filter 24 can absorb any wavelength which is beyond the 4-380 nm ranges, i.e. any wavelength below and beyond will be absorbed by the filter 24. Accordingly, only the light beam having the wavelength 4˜380 nm can pass the filter 24, and any wavelength other than that range will be filtered.

As similar to the first embodiment, the waveguide 22 includes a plurality of light incident ports (not shown), and a plurality of light emitting ports (not shown). The filter 24 is arranged between the ultraviolet light source 20 and the multiple light incident ports. The light beam projected from the ultraviolet light source 20 will enter the multiple incident ports and further into the waveguide 22 after it passes through the filter 24. The light beam will come out from the multiple emitting ports after one or more than once refraction within the waveguide, and then projects to the sealant 18 to be cured.

In the present invention embodiment, the waveguide 22 includes a plurality of fiber optics 220 arranged in parallel to each other. A first end of the fiber optics 220 serve as the light incident ports to receive the light beam projected from the ultraviolet light source 20. The second end of the fiber optics 220 serve as light emitting ports scattered and distributed according to the positions of the sealant to be cured.

According to the principle of total reflection, the fiber optic 220 can readily change the path of the light traveling within the fiber optic. In this embodiment, the light beam projected from the ultraviolet light source 20 may undergoes one or several total internal reflection within the fiber optic 220 before the light beam projects out of the light emitting port, and eventually shine upon the sealant to be cured. The light emitting ports oldie fiber optics 220 can be readily arranged and distributed according to the sealant to be cured. Accordingly, the light beam of out of the light emitting ports of the waveguide 22 will only project onto the sealant to be cured. By this arrangement, not only will the efficiency of the utilization of the ultraviolet light increase, but also effectively prevent the pre-matured random alignment of the molecular of the liquid crystal because of the exposure of the ultraviolet light.

For the same substrate 21, if the area of the sealant is “a′”, and those non-sealant area is “b′”, with the same amount needed to cure the sealant, the actual amount of the energy from the ultraviolet light source is “a′/(a′+b′), it is merely a fraction of what prior art needed. Accordingly, the energy needed from the ultraviolet light source 20 can be reduce to “a′/(a′+b′)”, i.e. either the quantity of the ultraviolet light tube 200 can be reduced, or the energy generated from the ultraviolet light tube can be reduced to only “a′/(a′+b′)” as compared to originally. The manufacturing cost is effectively reduced. On the other hand, the ultraviolet light tubes 200 of the ultraviolet light source 20 can be centralized because of the application of the waveguide. As a result, in case of any replacement of the ultraviolet light tube 200, the maintenance can be readily done. As it is similar to what the first embodiment discloses, not detailed description is given.

The present invention further introduces a method for curing the sealant and which includes the steps of following:
a) providing an ultraviolet light source emitting ultraviolet light beam;
b) providing a waveguide having multiple light emitting ports directing the ultraviolet light beam toward an area in which the sealant locates after the light beam is reflected within the waveguide; and
c) projecting the light beam through the multiple light emitting ports toward the sealant to be exposed.

Furthermore, after the position of the sealant to be cured is changed, the multiple light emitting ports are adjusted accordingly such that the multiple light emitting ports are aligned with the sealant to be cured.

As compared to the existing prior art, the curing device and the method of curing the sealant made according to the present invention can readily concluded with the following advantages: since the efficiency of the utilization of the ultraviolet light source is increased, the quantity of ultraviolet light tubes, which are the main cost of the curing device, can be readily reduced. In addition, the light emitting ports can be readily directed only to the sealant, thereby reducing the pre-matured random alignment of the molecular of the liquid crystal accidentally exposed to the ultraviolet light beam.

In conclusion, the curing device and the method for curing the sealant for LCD panel made in accordance with the present invention can readily increase the efficiency of utilization of the ultraviolet light source, while it can readily reduce the cost associated thereof. In addition, since the ultraviolet light beam is precisely directed to the area in which the sealant locates, the liquid crystal can be properly protected from pre-matured random alignment of the molecular of the liquid crystal resulted from exposure of the ultraviolet.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

1. A curing device for sealant of LCD panel, comprising an ultraviolet light source and a waveguide, wherein a light beam from the ultraviolet light source is directed into the waveguide which includes multiple light emitting ports, wherein the ultraviolet light beam from the light source emits from the multiple ports after refractions within the waveguide, wherein the multiple ports are arranged in alignment to the sealant, wherein the waveguide includes multiple light incident ports, wherein the curing device further includes filter units arranged between the multiple light incident ports and the ultraviolet light source, wherein the light beam from the ultraviolet light source is directed into the waveguide from the multiple light incident ports after passing through the filter unit, the waveguide including multiple L-shaped waveguide tubes, and each of the L-shaped waveguide tube includes first and second ports on both ends, wherein first port receives the light beam from the ultraviolet light source, the second port is directed and aligned toward the sealant, wherein the L-shaped waveguide tube has a telescopic configuration.

2. The curing device as recited in claim 1, wherein the filter absorbs the wavelength which is longer and shorter than the wavelength of the ultraviolet light.

3. The curing device as recited in claim 1, wherein each of the waveguides includes an internal refractive surface which directs the light beam from the first port to the second port, and finally to the correction in which the sealant locates.

4. A curing device for sealant, comprising an ultraviolet light source and a waveguide, wherein light beam emitted from the ultraviolet source is directed into the waveguide, wherein the waveguide includes multiple light emitting ports, wherein the light beam is emitted from the light emitting ports after reflected within the waveguide, wherein the light emitting ports are arranged with respect to an area in which the sealant is located.

5. The curing device for sealant as recited in claim 4, wherein the waveguide includes multiple light incident ports, and further including a filter arranged between the ultraviolet light source and the multiple light incident ports, wherein the light beam emitted from the ultraviolet light source enters into the waveguide after the light beam passes through the filter and entering through the light incident ports.

6. The curing device as recited in claim 5, wherein the filter absorbs the wavelength which is longer and shorter than the wavelength of the ultraviolet light.

7. The curing device for sealant as recited in claim 4, wherein the waveguide includes a plurality of fiber optic bundled together, a first end of the fiber optic is directed toward the ultraviolet light source, and the second end is directed to the sealant to be cured.

8. The curing device as recited in claim 4, wherein the waveguide includes multiple L-shaped waveguide tubes, and each of the L-shaped waveguide tube includes first and second ports on both ends, wherein first port receives the light beam from the ultraviolet light source, the second port is directed and aligned toward the sealant, wherein the L-shaped waveguide tube has a telescopic configuration.

9. The curing device as recited in claim 8, wherein each of the waveguides includes an internal refractive surface which directs the light beam from the first port to the second port, and finally to the correction in which the sealant locates.

10. The curing device as recited in claim 8, wherein the waveguide has a telescopic configuration.

11. A method for curing sealant of a LCD panel, comprising the steps on
a) providing an ultraviolet light source emitting ultraviolet light beam;
b) providing a waveguide having multiple light emitting ports directing the ultraviolet light beam toward an area in which the sealant locates after the light beam is reflected within the waveguide; and
c) projecting the light beam through the multiple light emitting ports toward the sealant to be exposed.

12. The method as recited in claim 11, wherein the light beam is reflected once or more than once within the waveguide before it is emitted from the multiple emitting ports.

13. The method as recited in claim 11, wherein after the position of the sealant to be cured is changed, the multiple light emitting ports are adjusted accordingly such that the multiple light emitting ports are aligned with the sealant to be cured.
